(19) United States
(12) Patent Application Publication
(10) Pub. No.: US 2003/0031134 A1
(43) Pub. Date: Feb. 13, 2003

(54) Providing real-time billing information to internet protocol telephones

(76) Inventor: Tienyu Chiu, Naperville, IL (US)

Correspondence Address: Lucent Technologies Inc., Docket Administrator (Rm. 3J-219), 101 Crawfords Corner Road, Holmdel, NJ, 07733-3030, US

(21) Appl. No.: 09/920,410

(22) Filed: Aug. 1, 2001

(51) Int. Cl. H04J 1/16

(52) U.S. Cl. 370/252; 370/401

(57) ABSTRACT

Call charge rates are made available in the IP Telephones to provide real-time call duration and fee information on the IP Telephones. A DHCP Server is used to provide the IP addresses of TFTP/DHCP/TOD Servers, IP Telephones MAC addresses to IP addresses mapping, the filename of initialization script, and other parameters. The rates are pre-installed in the TFTP Server and can be downloaded to IP Telephones by using the IP address of TFTP Server provided by DHCP Server. A Time of Day (TOD) Server is used to support the time synchronization between Call Feature Server/Media Gateway Controller and the IP Telephones. Fees are calculated, displayed and stored in the IP Telephones. A PC or workstation is used to retrieve the charge records from the IP Telephones that are co-located at the same corporate site for further billing processing (evaluations, verifications, etc.).

### FIELD OF THE INVENTION

This invention relates to features and capabilities of Internet Protocol (IP) Telephones and, more specifically, to a feature for providing real-time billing and timing information directly to IP Telephone end users.

### BACKGROUND OF THE INVENTION

Internet Protocol (IP) telephones are becoming more common, as more businesses and individuals opt for packet switched technology rather than the “traditional” (but currently more expensive) circuit switched technology. As more service providers are supporting IP telephones, they are encountering a growing demand for features from customers and a simultaneous need to develop features to differentiate their service from other service providers. At the same time, service providers are developing methods for billing customers for IP telephone services. These billing methods for the most part are based on the billing methods used in circuit switched technology.

In the illustration of prior art of FIG. 1, a circuit switch network is shown generally at 10, comprising an analog telephone 20 connected to a circuit switched access network 22. In the circuit switched network 10, billing capabilities are provided in a Class 5 (local) switch 25. The Class 5 switch 25 uses predefined charging rates, network time, charging capabilities to generate billing records. The billing records reflect call fees that are calculated based on the pre-defined rates per unit of time (usually minutes), and any other charging capability that affects the fee. The switch generates billing records and delivers these billing records to a billing center 30 for production of user billing statements.

A packet switch network, such as an IP-based network, is shown generally at 40. In this network 40, an IP telephone 45 is connected via a packet switched access network 50 to a call feature server or media gateway controller 60 (depending upon the network architecture). The central call feature server/media gateway controller 60 also provides billing capabilities for IP telephone 45 to generate billing records in a manner identical to the Class 5 switch 25. Billing records thus generated are delivered to a billing center 30, just like circuit switched network 10.

In the above-described traditional call charging approaches illustrated in FIG. 1, subscribers (both analog and IP telephone users) cannot know by any means the detailed billing information on each call until receiving a monthly statement. Some telephone instruments provide a call timer; but this is usually just a local clock built into the telephone that is not coordinated with network time. Actual network connect time can only be approximated. Further, the call cost can only be calculated by the user manually determining the current billing rate and manually calculating the cost of the call after the call is finished. Some service providers will tell the user the cost of a call, but only after the call is completed; and even then some service providers insist that this service be setup before the call is started. Using the approaches described above, it is generally impossible or at least very time consuming for the end users to verify fees listed in the billing statement, once the statement arrives.

### SUMMARY OF THE INVENTION

This problem is solved and a technical advance is achieved in the art by a system and method that provides IP Telephone users with the abilities to read the fee information from the telephone's display in real-time. Advantageously, the network time of day information may also be displayed.

Call charge rates are made available in the IP Telephones to provide real-time call duration and fee information on the IP Telephones. A Dynamic Host Configuration Protocol (DHCP) Server is used to provide the IP addresses of Trivial File Transfer Protocol (TFTP) and Time of Day (TOD) Servers, IP telephones MAC addresses to IP addresses mapping, the filename of initialization script, and other parameters. Billing rates are pre-installed in the TFTP Server and are downloaded to IP telephones. The IP telephones use the IP address of TFTP Server provided by DHCP Server to obtain this information. The TOD Server is used to support the time synchronization between Call Feature Server/Media Gateway Controller and the IP telephones. Fees are calculated, displayed and stored in the IP telephones.

An IP telephone can thus calculate a fee for the call based on current rates and network time. Fee and network time are periodically updated and displayed on the screen during the call. At the end of the call, a billing record is generated and stored in the IP Telephone. A PC or workstation can retrieve the records from the IP telephone via a LAN (or similar) connection. Advantageously, if the service provider changes the rates at any time, the new rates are downloaded to all affected IP telephones.

### BRIEF DESCRIPTION OF THE DRAWINGS

A more complete understanding of this invention may be obtained from a consideration of the specification taken in conjunction with the drawings, in which:

FIG. 1 illustrates a prior art telephone network billing architecture;

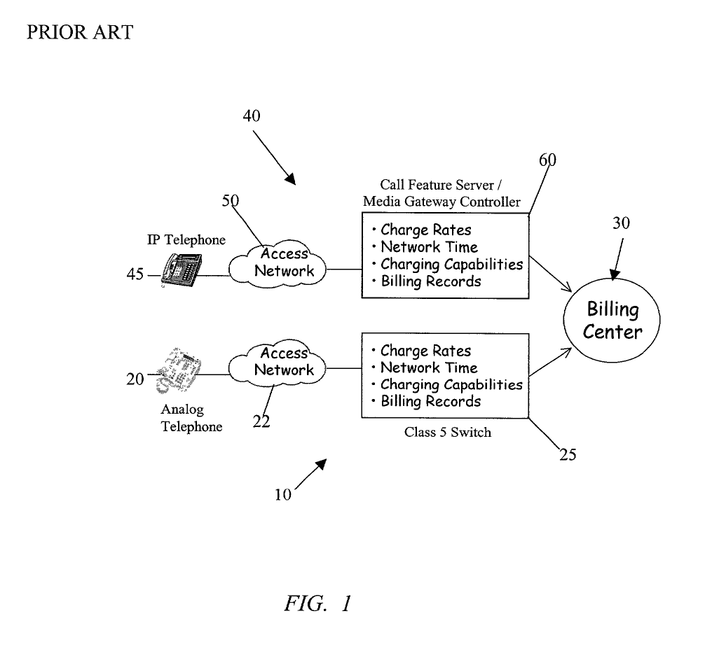

FIG. 2 is a block diagram of a packet switch communications network in which an exemplary embodiment of this invention is implemented;

FIG. 3 is a message flow diagram of IP telephone initialization according to an exemplary embodiment of this invention;

FIG. 4 illustrates an exemplary embodiment of bow fees are calculated, displayed and stored in an IP telephone; and

FIG. 5 shows data in each network element that is relevant to the exemplary embodiment of this invention.

### DETAILED DESCRIPTION

To facilitate understanding of this specification by one skilled in the art, Initialisms will generally be used in this Specification. The following table summarizes the Initialisms used in this Specification.

| | |
|---|---|
| ATM | Asynchronous Transfer Mode |
| CFS | Call Feature Server |
| DHCP | Dynamic Host Configuration Protocol |
| EMS | Element Management System |
| IETF | Internet Engineering Task Force |
| IP | Internet Protocol |
| LAN | Local Area Network |
| MAC | Media Access Control |
| MGC | Media Gateway Controller |
| NE | Network Element |
| NTP | Network Time Protocol |
| TFTP | Trivial File Transfer Protocol |
| TOD | Time of Day |
| VoIP | Voice over Internet Protocol |

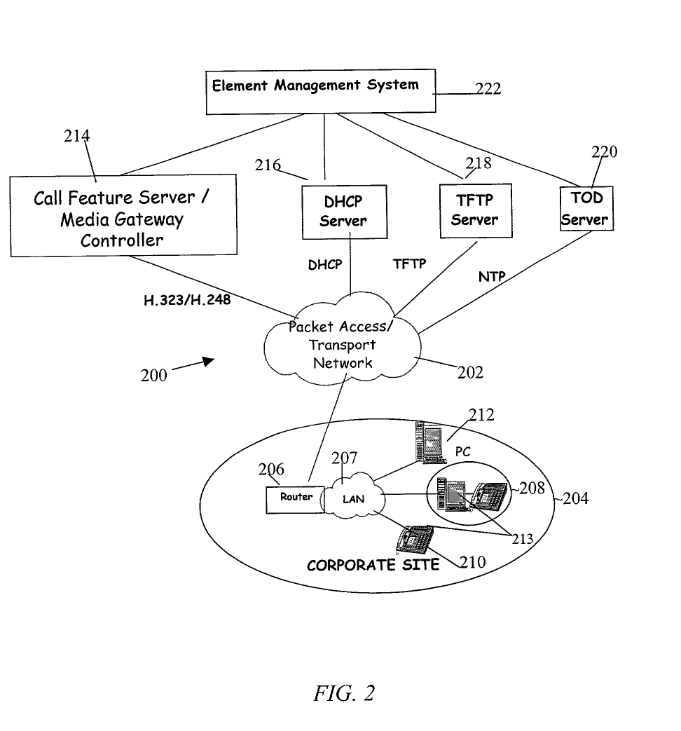

Turning now to FIG. 2, a block diagram of a packet network 200 supporting IP telephones according to an exemplary embodiment of this invention is shown. At the heart of packet network 200 is a packet access/transport network 202. Packet access/transport network 202 may comprise, for example, an asynchronous transfer mode (ATM) network, the Internet or some other public or private backbone packet network.

A corporate site 204 that uses 1P telephones is connected to packet access/transport network 202 at a router 206. Router 206 is well known in the art and thus not further discussed. Router 206 is connected to a local area network (LAN) 207, which, in this exemplary embodiment, interconnects a plurality of IP telephones, represented by IP telephones 208 and 210, and one or more PC's or workstations, represented by PC 212. IP telephones 208 and 210 each includes a display 213. IP telephone 208 comprises a PC. This type of IP telephone 208 is known in the art as a “soft IP telephone”, because the PC provides telephony functionality. IP telephone 210 is called a “hard IP telephone” and is well known in the art and are not discussed further. Further, IP telephones 208 and 210 include processing and signaling capabilities upon which this invention builds.

IP telephony in general is supported by call feature server/media gateway controller (CFS/MGC) 214. CFS/MGC 214 provides a telephony interface for the users of IP telephones 208 and 210, and also supports telephony features and connectivity to other IP telephones and to the circuit switched network (not shown but well known in the art). A dynamic host configuration protocol (DHCP) server 216, a trivial file transfer protocol (TFTP) server 218 and a time of day (TOD) server 220 are also used to support IP telephony in this exemplary embodiment. All of these are under the control of an element management system (EMS) 222 that manages and coordinates the operation of the DHCP 216, TFTP 218 and TOD 220 servers. All of these servers are known in the art of IP telephony and will therefore not be described further. While the above-listed servers are shown as separate units, they may reside on the same hardware platform.

This invention provides billing information on and for IP Telephones 208 and 210. As noted previously, this capability is not available in the traditional approaches. This invention contemplates pre-installing call billing rates in the TFTP server 218. The rates in the TFTP server 218 must be identical to the rates in the CFS/MGC 214, although their formats may be different. The rates are contained in a file with a unique version number. Other application software may also reside on TFTP server 218 that is downloaded to IP telephones 208 and 210 upon initialization, as is known in the art.

An initialization script file is pre-installed in the TFTP server 218 for each IP telephone 208 and 210. The initialization script includes the name of the rate file and the names of other application software file (also called “images” in the art) that are required to initialize an IP telephone. DHCP server 216 maintains a mapping table that maps media access control (MAC) addresses to IP addresses for all IP telephones in its area.

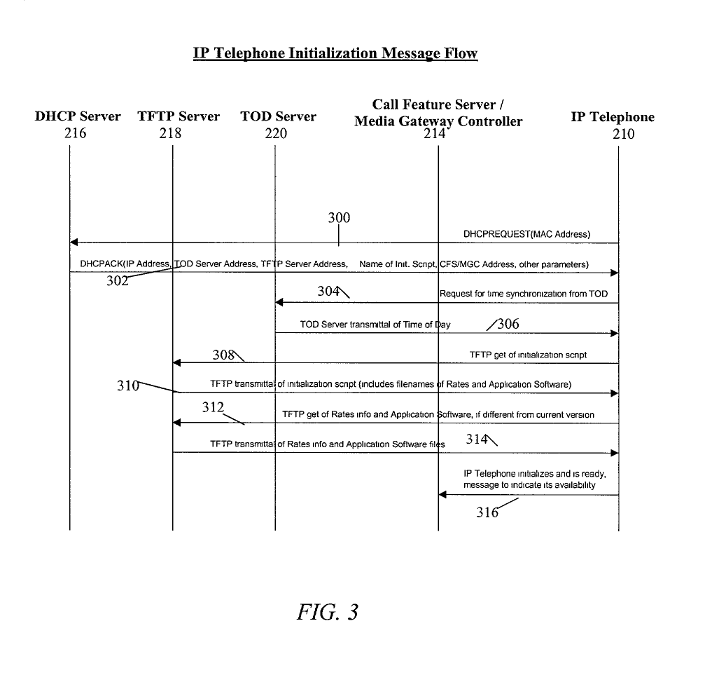

FIG. 3 is a message flow diagram of communication among the elements of FIG. 2 during an IP telephone initialization, according to an exemplary embodiment of this invention, in order to provide the functionality of calculating and displaying call billing information. An IP telephone may initialize, for example, when it is first plugged into LAN and/or when it is powered up. Further, if IP telephone becomes disconnected and then reconnected, it reinitializes itself. For purposes of explaining this exemplary embodiment, IP telephone 210 will be used. During initialization of IP telephone 210, IP telephone 210 provides its unique MAC address and telephone type to DHCP server 216 in message 300. DHCP server 216 responds to IP telephone 210 with the IP addresses of TFTP server 218, TOD server 220 and CFS/MGC 214 in message 302. This message also contains the filename of the initialization script based on the phone type.

IP telephone communicates with TOD server by using the IP address provided by DHCP server to request time synchronization in message 304. TOD server delivers time information to IP telephone 210 via, for example, network time protocol (NTP) in message 306. IP telephone 210 synchronizes the time and displays the time on the screen after receipt of message 306.

IP telephone 210 requests and receives its unique initialization script from TFTP server by using the IP address and filename provided by DHCP server in message 308. Included in the initialization script message 310 are the filenames/version numbers of the rate data and other application software images for this particular IP telephone 210. IP telephone 210 compares the version numbers with the existing ones stored in, for example, its firmware. If the version numbers are different, IP telephone 210 requests a new download of rates and/or application software from the TFTP server in message 312 and receives them in message 314.

IP Phone initializes and communicates with CFS/MGC in message 316. Whenever the rates are changed in the TFTP server, EMS coordinates the change among DHCP, CFS/MGC, and TFTP servers and downloads the new rates to IP Telephones.

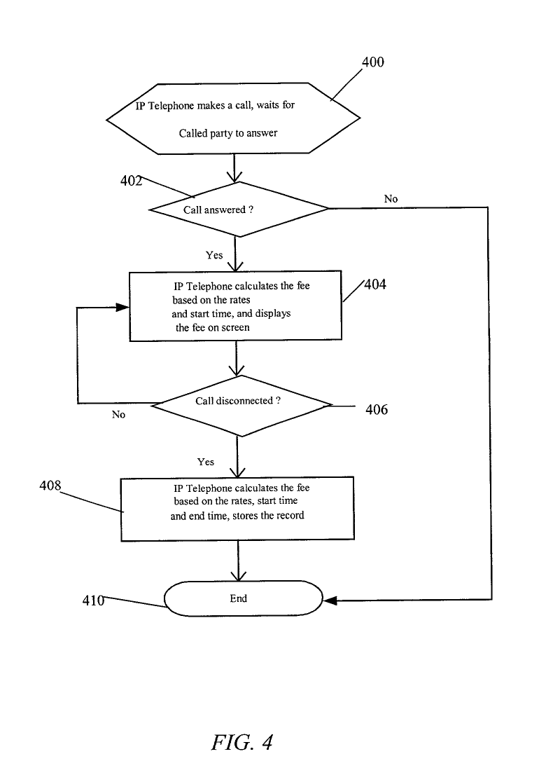

FIG. 4 comprises a flow chart illustrating how a fee for a telephone call is calculated, displayed and stored in the IP telephone. Processing begins in 400, where IP telephone makes a call and waits for an answer. When a call originating from an IP telephone is answered (answer supervision received), as determined in decision diamond 402, the IP telephone starts calculating the fee based on the rates and the network time in action box 404. The call duration and fee are displayed on the IP telephone and are refreshed regularly until the call is disconnected as determined in decision diamond 406. The charge rates sometimes may change during a call based on the time, the IP telephone may have the capability to adjust and calculate the fee accordingly.

After the call is completed, a billing record is generated and stored in the IP telephone in action box 408. This record contains at least the Start Time, End Time and the fee. A PC or workstation connected to the LAN may retrieve the billing records from any or all IP telephones. Processing ends in 410.

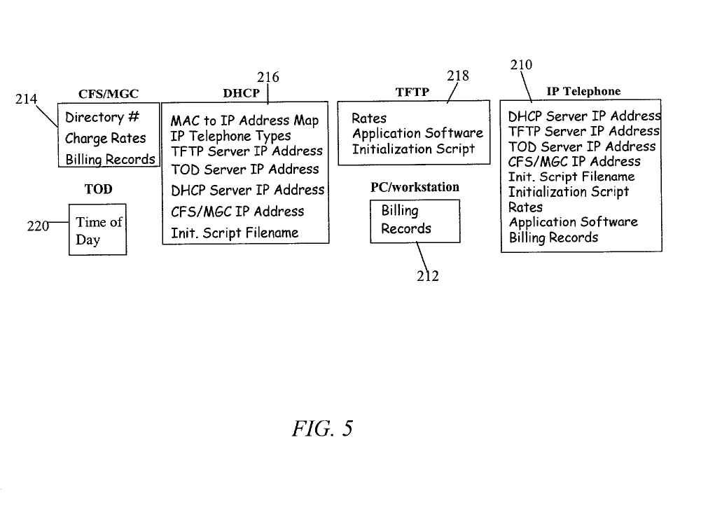

The data stored/created in each element to support this invention are shown in the tables of FIG. 5. CFS/MGC 214 stores the directory number of IP telephone 210, the charge rates for it, and any billing records. TOD server 220 maintains the time of day for the network. DHCP server 216 maintains the MAC to IP address mapping, IP telephone types, TFTP server IP address, TOD server IP address, DHCP server IP address, CFS/MGC IP address and the initialization script filename for each IP telephone. TFTP server 218 stores and maintains the rates file, application software files and initialization script for each IP telephone. The PC/workstation 212 maintains local copies of billing records. The IP telephone 210 stores the following data after initialization: DHCP server IP address, TFTP server IP address, TOD server IP address, CFS/MGC IP address, initialization script file name, initialization script, call billing rates, application software images and billing records.

It is to be understood that the above-described embodiments are merely illustrative principles of the invention and that many variations may be devised by those skilled in the art without departing from the scope of this invention. It is, therefore, intended that such variations be included within the scope of the following claims.

What is claimed is:

1. A method for use in an Internet Protocol (IP) telephone connected to a network comprising a plurality of network elements, said IP telephone including a display, for determining and displaying call billing information, said method comprising the steps of:
a) initializing said IP telephone with billing rates and time of day;
b) completing a telephone call from said IP telephone;
c) calculating a call cost from said billing rates and the time of day;
d) displaying said call cost on said IP telephone display;
e) repeating steps b through d) until said call disconnects;
f) calculating a total cost for said call; and
g) storing said total cost for said call.

2. A method in accordance with claim 1 wherein step a) comprises downloading the billing rates and time of day from servers in the network.

3. A method in accordance with claim 1 wherein said IP telephone is connected to said network via a local area network (LAN) and step a) occurs when said IP telephone is connected to said LAN.

4. A method in accordance with claim 1 wherein said IP telephone is connected to said network via a local area network (LAN) and step a) occurs when said IP telephone is connected to a power supply.

5. A method in accordance with claim 1 wherein said network includes a Trivial File Transfer Protocol (TFTP) server including said billing rates, wherein step a) comprises obtaining said billing rates from said TFTP server.

6. A method in accordance with claim 5 further including the step of downloading billing rates whenever said billing rates change on said TFTP server.

7. A method in accordance with claim 5 wherein said IP telephone is initialized using initialization scripts, and wherein step a) comprises obtaining initialization scripts from said TFTP server.

8. A method in accordance with claim 1 wherein said network includes a Time of Day (TOD) server that provides time of day information to said network elements, wherein step a) comprises obtaining the time of day from said TOD server.

9. A method in accordance with claim 8 wherein step d) further includes displaying the network time of day on the IP telephone display.

10. A method in accordance with claim 1 wherein said IP telephone is connected to said network via a LAN, wherein a PC is also connected to said LAN, said method further including the step of:
h) storing said total cost as a record for said call on said PC.

11. A method in accordance with claim 10 further including the step of:
i) querying and sorting said records on said PC.

12. A method in accordance with claim 11 further including the step of:
j) printing said records.

13. A method in accordance with claim 1 wherein said IP telephone is connected to said network via a LAN, wherein a workstation is also connected to said LAN, said method further including the step of:
h) storing said total cost as a record for said call on said workstation.

14. A method in accordance with claim 13 further including the step of:
i) querying and sorting said records on said workstation.

15. A method in accordance with claim 14 further including the step of:
j) printing said records.

16. A method for initializing an IP telephone for displaying and storing call billing information, said IP telephone connected to a network, said network using Internet Protocol (IP) and including a Dynamic Host Configuration Protocol (DHCP) server, a Trivial File Transfer Protocol (TFTP) server, and a Time of Day (TOD) server, said method comprising the steps of:
requesting initialization information from said DHCP server;
receiving the IP address of TFTP server and the filename of an initialization script file for said IP telephone from said DHCP server;
requesting said initialization script file from said TFTP server;
receiving from TFTP Server the initialization script file;
requesting time of day information from said TOD server;
receiving from said TOD server the network time of day;
requesting billing rates and application software images from said TFTP server; and
receiving from TFTP server the rates information and other application software images.
